(19) United States
(12) Patent Application Publication
(10) Pub. No.: US 2014/0167545 A1
(43) Pub. Date: Jun. 19, 2014

(54) Magnetic Couplings

(71) Applicants: Christopher Bremner, London (GB); Radu Iliuta, Montpellier (FR)

(72) Inventors: Christopher Bremner, London (GB); Radu Iliuta, Montpellier (FR)

(21) Appl. No.: 13/980,362

(22) PCT Filed: Jan. 18, 2012
(86) PCT No.: PCT/GB2012/050103

§ 371 Date: Jan. 23, 2014

(30) Foreign Application Priority Data
Jan. 18, 2011 (GB) 1100826.5

(51) Int. Cl. H02K 49/10

(52) U.S. Cl. CPC H02K 49/104
USPC 310/103

(57) ABSTRACT

A magnetic coupling (20) comprises first and second coupling members (21, 23), arranged concentrically within one another. Each coupling member (21, 23), has a respective series of projecting permanent magnets (3). On each of the (5) coupling members (21, 23), each of the magnets 3 has opposite faces of opposite polarity and consecutive magnets (3) are spaced from one another with the faces of consecutive magnets (3) of alternating polarity. The magnets (3) on the coupling member (21) are disposed opposite but offset from the magnets (3) on the coupling member (23). Also disclosed is a coupling member assembled by bolts or rods (10) engaging permanent magnets (FIG. 8) and permanent magnet coupling members polarised perpendicularly to their axes of rotation (FIG. 18c).

The present invention relates to magnetic couplings.

Magnetic couplings are a well-known alternative to other mechanical couplings in torque transmission systems. They provide torque transmission with improved efficiency, without the energy losses incurred through mechanical drives, and allow a driven component to be isolated from a drive system. They can be configured to slip when excessive torque occurs, and eliminate the problems associated with rotating shaft seals such as inherent leakage and friction.

Prior proposals for magnetic couplings include WO 2010/121303 and US 2008/0217373.

Preferred embodiments of the present invention aim to provide magnetic couplings that are more efficient, safer and more economical than previously proposed magnetic couplings.

In the context of this specification, the term ‘magnetic coupling’ is used in a general sense to refer to arrangements in which members are magnetically coupled together, to include arrangements that might be known as, for example, magnetic couplers, magnetic drives and magnetic interlocks.

According to one aspect of the present invention, there is provided a magnetic coupling comprising a first permanent magnet mounted on a first coupling member and presenting a first polarised face; and a second permanent magnet mounted on a second coupling member and presenting a second polarised face; wherein said first and second coupling members are disposed opposite but offset from one another and said first and second polarised faces are of opposite polarity and face one another.

Preferably, said magnets project from said coupling members.

Preferably, said magnets are of rhomboid shape.

Preferably, each of said magnets has two polarised faces of opposite polarity.

A magnetic coupling as above preferably comprises a plurality of said first coupling members with respective first magnets, arranged opposite to and alternating with a plurality of said second coupling members with respective second magnets.

In another aspect, the invention provides a magnetic coupling comprising first and second coupling members, each having a respective series of permanent magnets that project from the coupling member; wherein, for each of the series, each of the magnets has opposite faces of opposite polarity and consecutive magnets are spaced from one another with said faces of consecutive magnets of alternating polarity; the coupling members being juxtaposed with the respective series of magnets disposed opposite but offset from one another.

Each of the magnets of each series may project into a space between two magnets of the other series, with opposing faces being of opposite polarity.

Preferably, said coupling members are rotary members with their respective magnets arranged around their periphery.

Preferably, said coupling members are arranged concentrically one inside the other.

According to another aspect of the present invention, there is provided a magnetic coupling member comprising a carrier and a plurality of permanent magnets mounted on the carrier, wherein each of the magnets is formed with at least one recess and a plurality of rods are provided on the carrier and engage the recesses to secure the magnets on the carrier.

Preferably, each of the magnets has a pair of said recesses at opposite sides of a base portion of the magnet.

Preferably, said carrier comprises a pair of elements arranged with the magnets between them, each of the elements carrying a series of rods that alternate with the rods on the other of the elements.

Preferably, each of the magnets projects from the carrier to define a salient pole.

Preferably, each of the magnets is polarised to afford a North Pole at one side of the magnet and a South pole at the other side.

Preferably, said rods are in the form of bolts.

According to a further aspect of the present invention, there is provided a magnetic coupling member comprising a body of permanently magnetic material arranged to rotate about a rotational axis, the body being polarised in a direction perpendicular to said rotational axis.

Preferably, said body is cylindrical.

Preferably, said body is of circular section.

A magnetic coupling member as above may comprise a plurality of said bodies arranged side by side, with their directions of polarisation offset from one another in a spiral pattern.

Such a magnetic coupling member may be provided in combination with a circular member with which the coupling member is magnetically coupled as a worm drive.

Magnetic coupling members as above may be arranged in a magnetic coupling, axially spaced from one another.

Magnetic coupling members as above may be arranged in a magnetic coupling, arranged concentrically within one another.

A metal sleeve may be provided around the body of at least one of the magnetic coupling members.

In a magnetic coupling or coupling member according to any of the preceding aspects of the invention, the or each permanent magnet or body of permanently magnetic material preferably comprises a rare earth material.

Preferably, said rare earth material comprises neodymium.

A magnetic coupling preferably comprises a plurality of magnetic coupling members according to any of the preceding aspects of the invention, magnetically coupled with one another.

Such a magnetic coupling may be a rotational coupling or a linear coupling.

For a better understanding of the invention and to show how embodiments of the same may be carried into effect, reference will now be made, by way of example, to the accompanying diagrammatic drawings, in which:

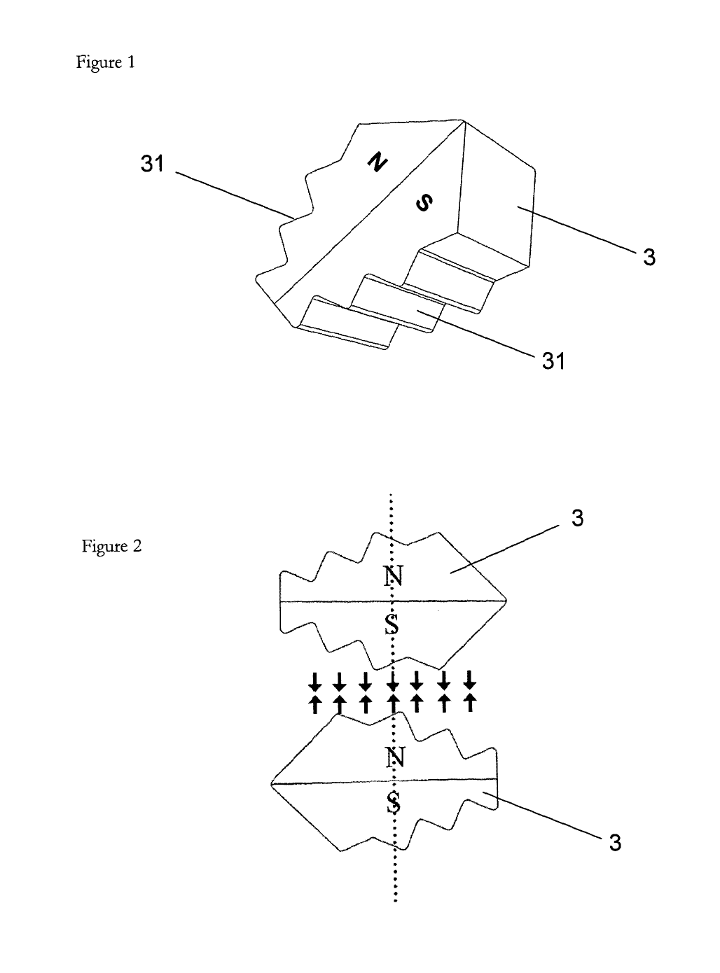

FIG. 1 shows one example of a rhomboid polarised magnet in isometric view;

FIG. 2 shows a pair of the rhomboid polarised magnets of FIG. 1, arranged side by side with their axes of symmetry parallel to each other, and showing magnetic forces therebetween;

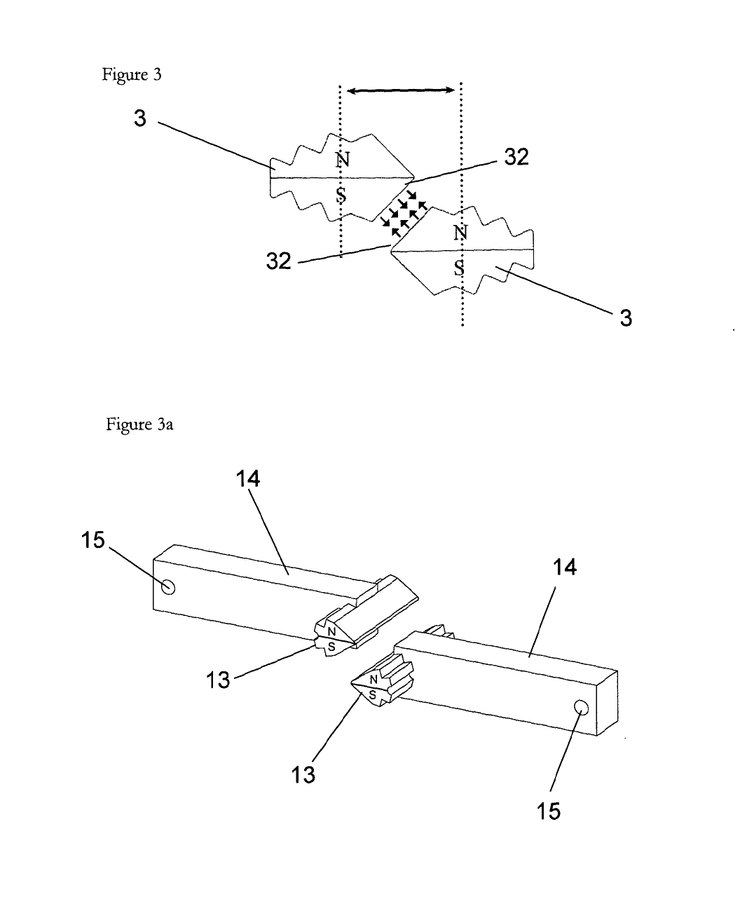

FIG. 3 shows the pair of rhomboid magnets arranged as in FIG. 2, but axially offset from one another;

FIG. 3a illustrates two magnets interlocking in mid-air;

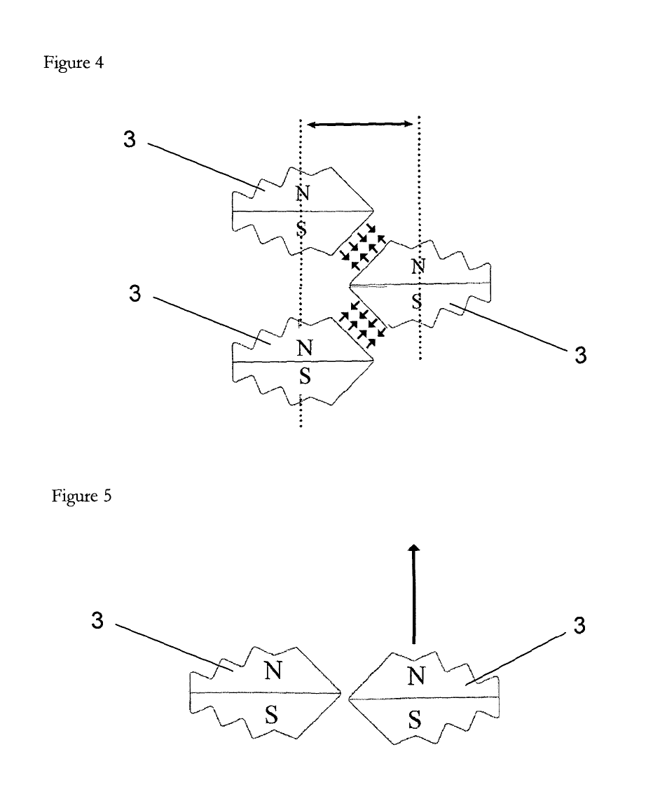

FIG. 4 is a view similar to that of FIG. 3, but showing a further magnet and magnetic forces;

FIG. 5 is a view similar to that of FIG. 3, but showing the magnets further axially offset but with their longitudinal axes closer together;

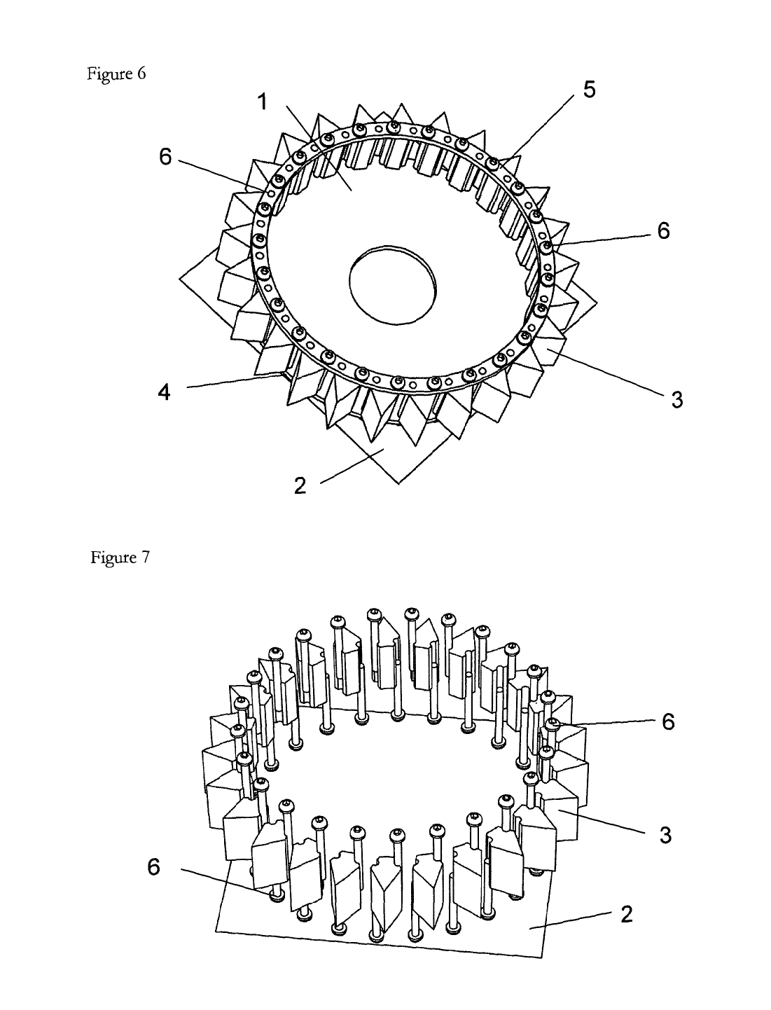

FIG. 6 shows one example of an embodiment of a magnetic coupling member in isometric view;

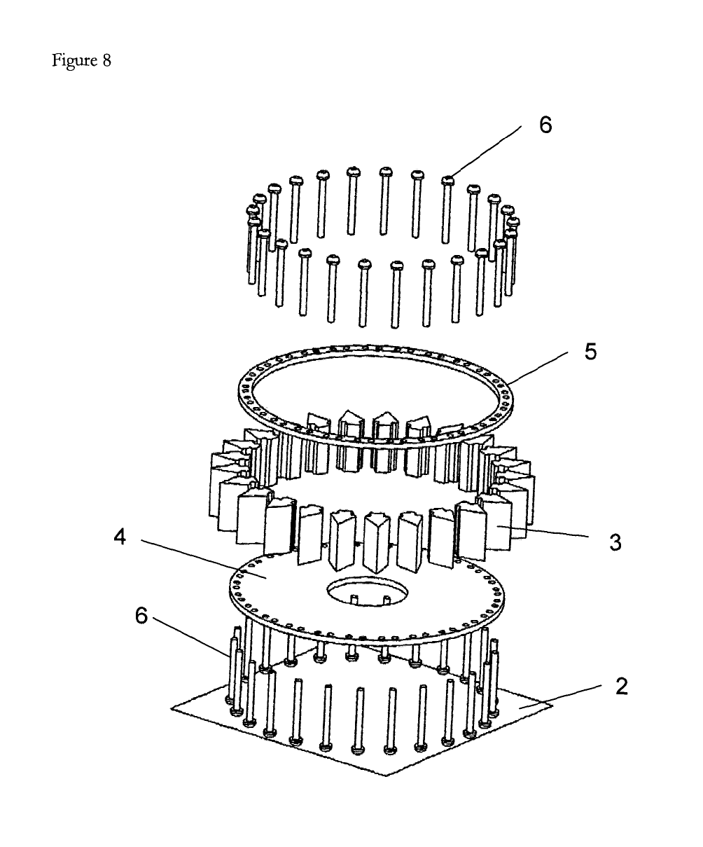

FIG. 7 shows an exploded view of the configuration of bolts and magnets in the magnetic coupling member of FIG. 6;

FIG. 8 shows an exploded view of the magnetic coupling member of FIGS. 6 and 7 with a coupling plate and ring;

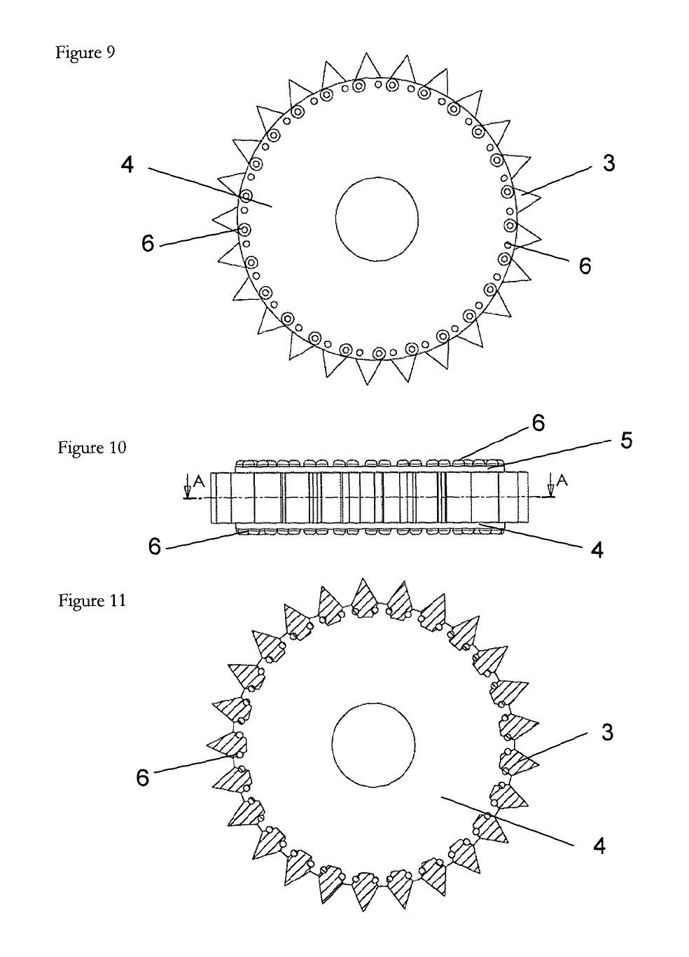

FIG. 9 shows a plan view of the radial magnetic coupling member of FIGS. 6, 7 and 8;

FIG. 10 shows a side view of the radial magnetic coupling member of FIGS. 6, 7 and 8;

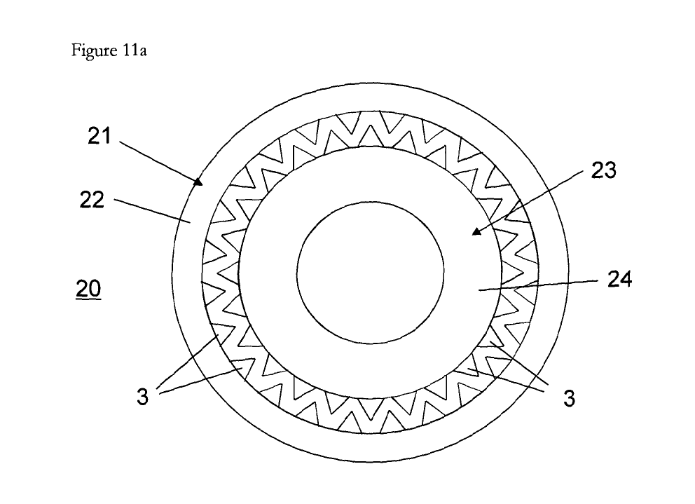

FIG. 11 shows a section A-A through the side view of FIG. 10, showing the integration of bolts and magnets;

FIG. 11a shows a magnetic coupling comprising inner and outer magnetic coupling members;

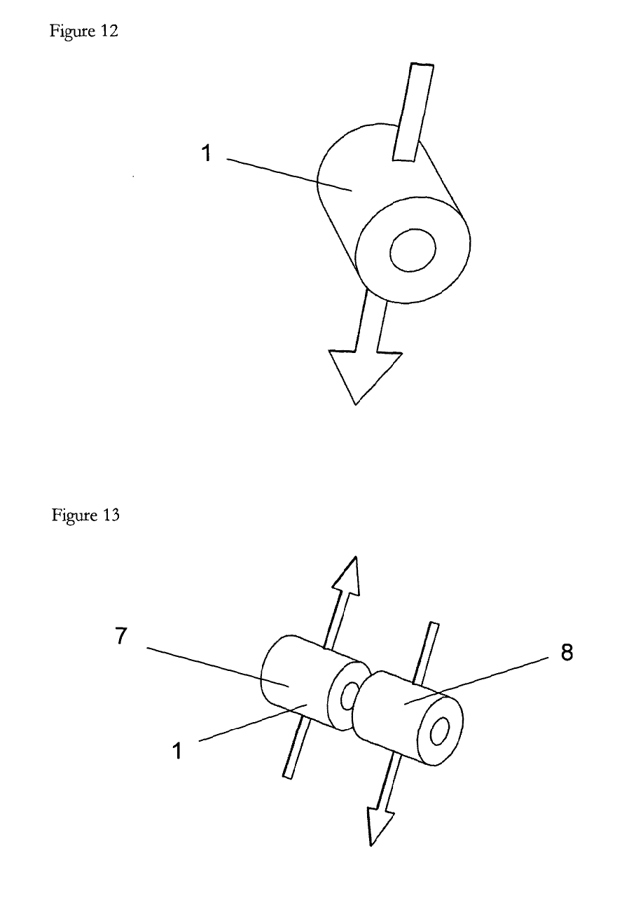

FIG. 12 shows one example of a magnetic coupling member with radial or perpendicular polarisation;

FIG. 13 shows two magnetic coupling members of FIG. 12 as a driver member and a driven member, with an air gap therebetween;

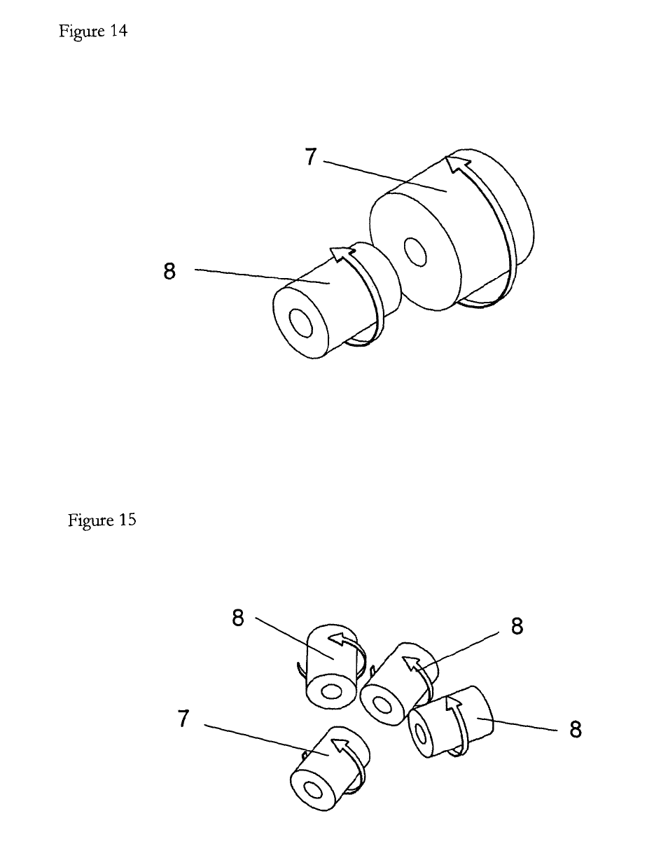

FIG. 14 shows a similar arrangement to that of FIG. 13, but where the driver member is greater in diameter than the driven member;

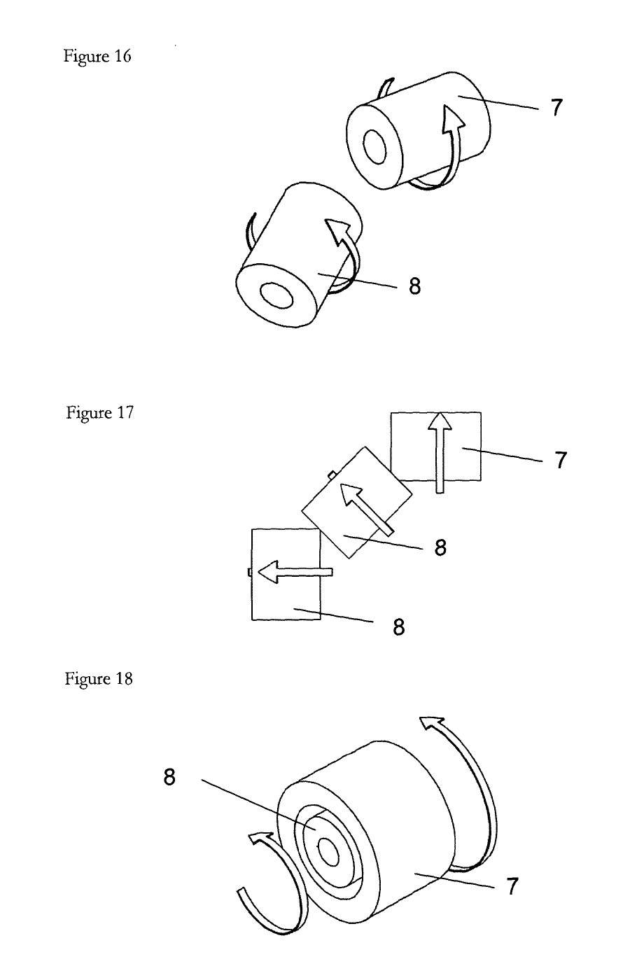

FIG. 15 shows one example of an arrangement of magnetic coupling members of FIG. 12, with one driver member to a plurality of driven members;

FIG. 16 shows another example of an arrangement of magnetic coupling members of FIG. 12, with driven member offset at an angle to the driver member;

FIG. 17 shows another example of an arrangement of magnetic coupling members of FIG. 12, with intermediary driven member to relay a torque transmission through 90 degrees;

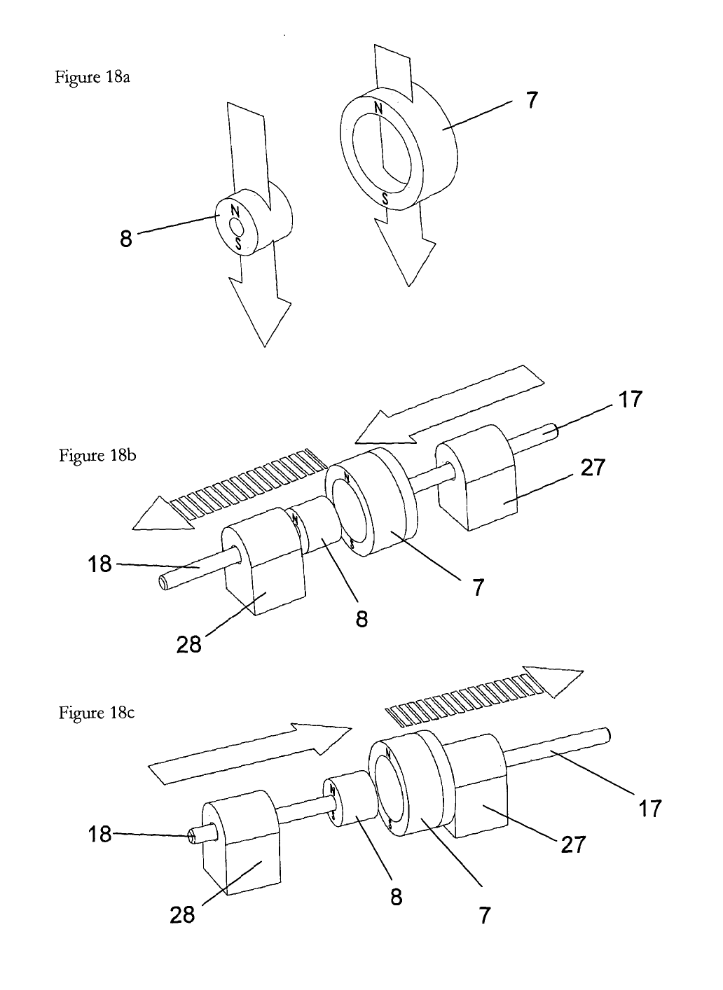

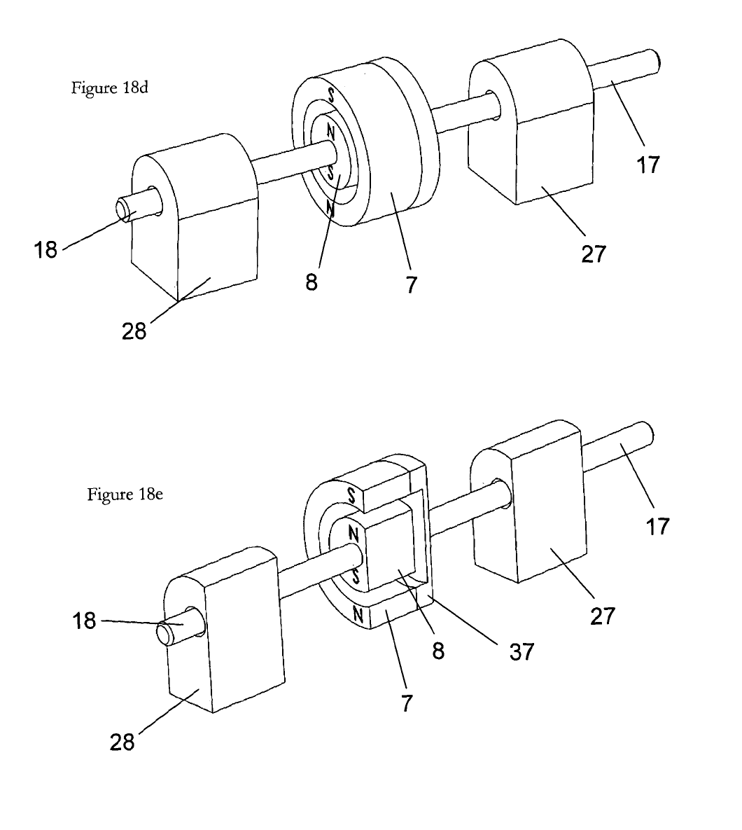

FIG. 18 shows another example of an arrangement of magnetic coupling members of FIG. 12, in drum configuration with driven member housed inside driver member;

FIG. 18a shows two magnetic coupling members with perpendicular polarisation;

FIG. 18b shows the two coupling members of FIG. 18a mounted on respective shafts, with movement in one direction;

FIG. 18c is a view similar to FIG. 18b, showing movement in an opposite direction;

FIG. 18d is a view similar to FIG. 18b, showing the coupling members in a drum configuration;

FIG. 18e is a cutaway view corresponding to FIG. 18d;

FIG. 19 shows an example of an arrangement of a magnetic coupling member of FIG. 12 arranged to drive an axially polarised array of magnets in circular configuration;

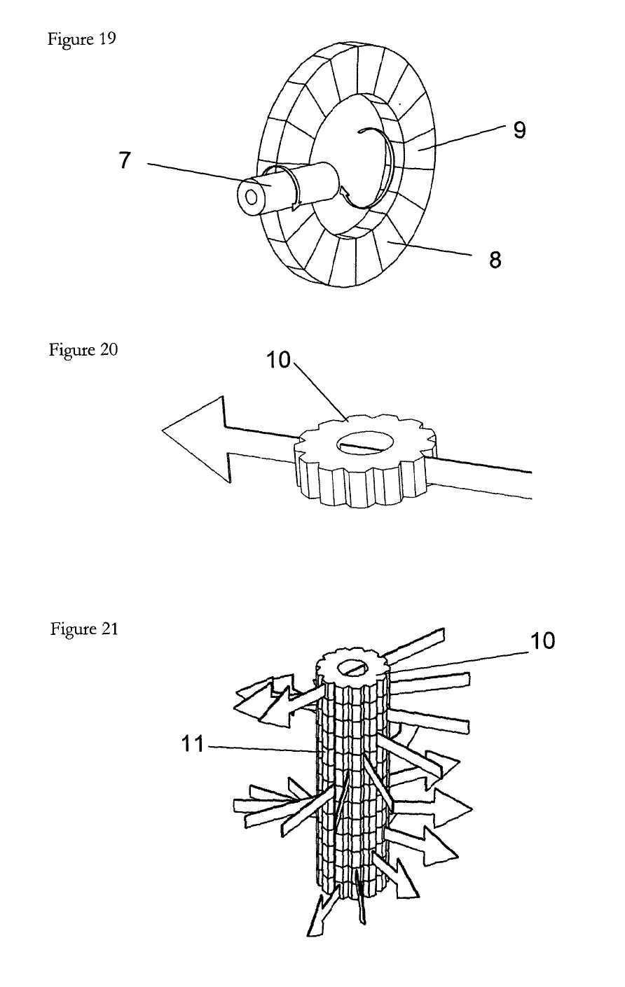

FIG. 20 shows a cylindrical magnet that is polarised perpendicular to its axis of rotation;

FIG. 21 shows one example of a plurality of cylindrical magnets of FIG. 20 joined together, with spiralling configuration of polarisation;

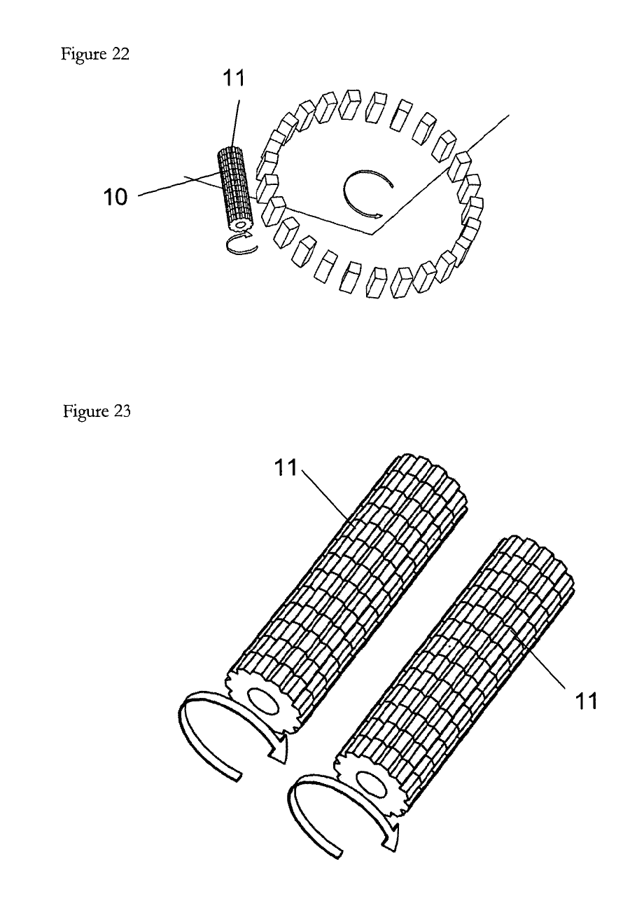

FIG. 22 shows the plurality of cylindrical magnets of FIG. 21 in use as a magnetic worm drive to drive a circular array of magnets; and

FIG. 23 shows the plurality of cylindrical magnets of FIG. 21 arranged to drive a further plurality of cylindrical magnets of FIG. 21.

In the figures, like references denote like or corresponding parts.

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical. As just one example, the shape of magnets 3 as illustrated in FIGS. 6 to 11 is not the only possible shape for use in such embodiments, and magnets 3 of such shape do not have to be used invariably with all of the other components shown in FIGS. 6 to 11.

FIG. 1 shows a permanent magnet 3 that presents a rhomboid shape, with a plurality of ribs 31 on opposing sides that are used to retain the magnet 3 in position within a circular or linear body that is provided with a complementary recess shaped to receive and engage with the ribbed sides 31. The magnet 3 is polarised as indicated in FIG. 1, with a north N pole extending along one side of the magnet 3 and a south S pole extending symmetrically along the opposite side.

The magnet 3 may be manufactured from a rare earth (e.g. neodymium), which can be moulded and sintered, and cut to shape with diamond wires. The rhomboid shape provides a relatively slim cross-section, similar to mechanical gears, and thus more magnets can be used per area. However alternative shapes to rhomboid may be adopted—e.g. circular or oval.

In FIG. 2, two magnets 3 are arranged side by side with their axes of symmetry parallel to each other and aligned on a central axis shown by a dotted line. The south pole S of the upper magnet 3 faces the north pole N of the lower magnet 3 and there is thus an attraction force between the two magnets 3. If released, the magnets will stick together.

In FIG. 3, the centres of the magnets 3 have been offset such that angled faces 32 of the magnets face each other. In this configuration, the surprising phenomenon has been observed that, even though N on one rhomboid magnet faces S on the other magnet, the magnets now interlock in mid-air with respect to each other with considerable force—that is, they adopt an equilibrium position with respect to one another. This is very significant because, if the magnets 3 are arranged in a ring or line, such as in a rotary coupler or a linear drive, they do not want to jump out of alignment, as may happen in prior art devices.

This phenomenon is illustrated in FIG. 3a, which shows two magnets 13 mounted on respective bodies 14 that are pivotally mounted at pivot points 15. The N and S poles of the magnets 13 face each other and, although the bodies 14 are free to pivot about their respective pivot points 15, they lock in a position as shown, leaving a considerable air gap.

FIG. 4 shows a further magnet 3, illustrating how the magnet 3 on the right (as seen) is located between the two facing magnets 3 on the right. The magnetic forces between the magnets 3 serve to maintain the magnets 3 in a state of equilibrium such that they tend to stay locked with respect to each other. FIG. 4, if extended to include an extended series of magnets 3 alternately on both left and right sides as seen, may represent either a linear drive or coupling, or a developed view of a rotary drive or coupling. Movement of the magnets 3 on the left side, up or down, as seen, will induce corresponding movement of the magnets 3on the right side as seen, due to the magnetic coupling forces between the magnets 3—and vice-versa.

In FIG. 5, even if the magnets are brought to a position where they can pass each other, they will still seek to interlock as in FIGS. 3 and 4—that is, they will not pass each other unless forced to. The interlocking magnetic field is weaker in this position, but will still have the same effect.

Configuring the magnets 3 with poles such that they both repel and attract one another, provides for a self-stabilised assembly, and creates a far stronger magnetic coupling 1 than conventional systems. A self-stabilising system is also much safer, avoiding the danger of magnetic elements being fired out of an assembly at high speed, as may happen in prior arrangements.

As indicated above, locating the magnets 3 in a suitable carrier requires the provision of a shaped recess to receive and engage with the ribbed sides 31. This typically requires expensive, precision cutting techniques. The embodiment of FIGS. 6 to 11 may be improved in this respect.

Magnetic couplings typically comprise a driver member and a driven member, which are configured to rotate about a common axis on bearings. Typically, a shaft is connected to the driver member and a shaft is connected to the driven member to provide torque transmission via driver member and driven member, without mechanical contact therebetween. FIG. 6 shows a configuration of either driver member or driven member 1 that forms part of a magnetic coupling 1.

As shown in FIGS. 6 and 7, the magnetic coupling member 1 comprises a plate 2 to support a disc 4 on which a plurality of permanent magnets 3 are mounted. A further ring 5 is used to clamp the magnets 3 in position about the disc 4. The disc 4 and the ring 5 are joined together by a plurality of rods in the form of bolts 6 passing through respective holes.

The provision of the bolts 6 to hold the magnets 3 in position reduces precision manufacturing requirements, and can therefore mitigate the associated costs of having to use specialist equipment. Containment rings for magnets, and other similar alternatives, have to be manufactured to extremely precise dimensions, and are therefore typically cut to shape with lasers. Incorporating the bolts 6 in place of a containment ring avoids the need to use expensive laser cutting processes during production. The bolts 6 do not require the same manufacturing precision as a containment ring. The other elements that make up the magnetic coupling 1 likewise do not require such precision engineering, such as the plate 2, disc 4, and ring 5, and can all be manufactured using plasma cutters, which provides a cheaper manufacturing alternative.

The magnets 3 are circumferentially disposed at substantially equal intervals about the periphery of the disc 4. When the magnetic coupling member 1 is magnetically coupled to a further magnetic coupling member, such that one forms a driver member and the other forms a driven member, each magnet on the driver member is configured to be magnetically coupled with respective magnets on the driven member with an air gap in between.

The magnets 3 are polarised and arranged such that they operate in repulsion as between driver member and driven member. Prior known magnetic couplings 1 are polarised and arranged such that the magnets 3 operate in attraction. In these prior systems the magnets must be finely balanced to reduce torsional vibration that is likely to occur. Such torsional vibration can greatly reduce the efficiency of the torque transmission and therefore the coupling. By operating in repulsion, losses due to torsional vibrations are minimised, and therefore the efficiency of the magnetic coupling 1 is improved. These systems allow for much larger magnetic couplings 1 to be used, and therefore much larger torques to be transmitted. They also allow for a greater air gap between magnetically coupled members. Such an arrangement can even allow for the coupled members to be separated by an obstruction such as a wall, thus transmitting torque through the obstruction.

The exploded view of FIG. 8 shows the magnetic coupling member 1, and the positioning of the disc 4 and the ring 5 within such an arrangement. The disc 4 and the ring 5 couple the magnets 3 together, being secured in place by the bolts 6. As shown in FIGS. 9 and 10, alternating bolts 6 pass through the disc 4 in opposite directions. It is important that the weight distribution and symmetry of the magnetic coupling 1 is maintained so as not to affect the torque when in operation.

FIG. 11 shows a section A-A through the side view of FIG. 10, and shows the shape of the magnets 3 in plan view. It also shows the position of the magnets 3 about the peripheral circumference of the disc 4. In particular, it may be seen that each magnet 3 is formed at its inner part with a pair of recesses, each arranged to engage with a respective one of the bolts 6 to secure the magnet 3 in position.

The bolts 6 may be replaced by rods that are threaded or otherwise secured to the disc 4 and ring 5.

FIG. 11a shows a magnetic coupling 20 comprising an outer magnetic coupling member 21 and an inner magnetic coupling member 23. The outer magnetic coupling member 21 comprises a ring 22 on which a plurality of permanent magnets 3 are mounted. The magnets 3 face radially inwardly and may be as described in the preceding embodiments, having North and South poles on adjacent faces and mutually spaced from one another. The inner magnetic coupling member 23 comprises a ring 24 on which a plurality of similar permanent magnets 3 are mounted, facing radially outwardly and each projecting into the space between two opposing magnets 3 on the outer member 21.

In use, the magnetic forces acting on the coupling members 21,23 are such that the coupling members interlock in an equilibrium position generally as illustrated. As the coupling members 21, 23 are circular, they experience equal and opposite magnetic forces at each two opposite points on their peripheries. As described above, the interleaved magnets 3 all assume an equilibrium position with respect to the adjacent magnets, so there is no tendency for the coupling members 21, 23 to move with respect to each other, from the equilibrium position as indicated. Thus, when the one of the coupling members 21,23 is caused to rotate about its axis, the other coupling member follows it, due to the interacting magnetic forces; the opposing magnets 3 never come into contact with one another.

It has been found that, with magnets 3 generally as shaped in FIGS. 1 to 11, there are three distinct juxtapositions of magnets 3 that will cause the coupling members 21,23 to assume an equilibrium position. Firstly, as illustrated, with shallow interleaving of the magnets 3. Secondly, with deeper interleaving of the magnets 3. And thirdly, in a configuration where the magnets 3 are not interleaved, but the inner magnets 3 are spaced by a small amount from the outer magnets 3. With a rotary coupling 20 as illustrated, the above-mentioned three juxtapositions correspond to the inner coupling 23 having a diameter relative to the outer coupling member 21 that is as illustrated, slightly greater than illustrated, and slightly less than illustrated.

An important practical advantage of couplings 20 as illustrated is that the coupling members 21, 23 tend naturally towards an equilibrium position. This means that, in contrast to known prior art, the coupling 20 can be assembled with relatively low precision; there is negligible danger of magnets colliding to cause damage to components; and negligible risk of magnets being expelled at dangerously high velocity. Thus, couplings 20 can be produced at much less cost.

Since the coupling members 21, 23 tend naturally towards an equilibrium position in which the coupling members 21, 23 are concentric, forces experienced by bearings for the coupling members 21, 23 are much less than in other, prior art proposals. This further facilitates the manufacture of magnetic coupling assemblies at low cost. The gravitational forces on the coupling members 21, 23 are low compared to the magnetic forces.

In FIG. 12, a magnetic coupling member 1 is cylindrical and intended for rotation about its longitudinal axis. It is polarised such that the polarisation is perpendicular to the axis of rotation.

When a magnetic coupling is made up of a driver member 7 and a driven member 8, each as shown in FIG. 12, with an air gap in between, as shown in FIG. 13, the driver member 7 conveys torque to the driven member 8 through the magnetic coupling provided by the field therebetween. The polarities of said driver and driven members are in opposite directions to each other and equal in magnitude, thus ensuring equilibrium of the magnetic coupling 1 and conveying rotation from the driver member 7 to the driven member 8.

Although only a single polarisation is shown in FIG. 12, such magnets 3 may also be multiply polarised to provide a plurality of poles, according to a required magnetic field for torque transmission.

Although the magnetic coupling member 1 is shown in FIG. 12 as being of circular cylindrical shape, other shapes may be used, such as cylinders of other section and blocks.

In the configuration shown in FIG. 13, the air gap between members 1 may be much greater than conventional couplers. This facilitates separation between the members 1, with the interposition of structural or functional elements (e.g. seals) that do not interrupt the magnetic flux significantly. A significant feature of magnetic coupling members 1 is that the magnetic field may extend much further than with known couplings.

As shown in FIG. 14, a similar arrangement of driver member 7 to driven member 8 can be used to provide torque transmission, where the driver member 7 is larger in diameter than the driven member 8—or the larger diameter member 8 may be the driver member and smaller diameter member 7 the driven member.

One driver member 7 can also be configured to drive a plurality of driven members 8, as shown in FIG. 15. The driven members 8 do not need to be positioned along the same axis of rotation as the driver member 7, but can be set at an angle to it. FIG. 16 shows an arrangement where the axis of rotation of the driven member 8 is at 45 degrees to the axis of rotation of the driver member 7.

In a situation where the driven member 8 has its axis of rotation positioned at 90 degrees to the driver member 7, one or more intermediary driven magnets 8 can be positioned therebetween, as shown in FIG. 17. The torque from the driver member 7 is conveyed to an intermediary driven member 8 at an angle of 45 degrees to the axis of rotation of the driver member 7, and further conveyed to a second driven member 8, positioned at an angle of 45 degrees to the axis of rotation of the driver member 7. This arrangement ensures a smoother transmission between the driver member 7 and the final driven member 8. Torque can therefore be transferred through any angle of driver member 7 to driven member 8, through the use of intermediary driven members 8 where necessary.

As shown in FIG. 18, a driven member 8 can be contained within a driver member 7 (or vice-versa), thus forming a magnetic coupling of drum configuration.

In FIG. 18a, magnet coupling members comprise a driver member 7 and a driven member 8, each of annular configuration and comprising a permanent magnet that is polarised perpendicular to their axis, as shown. In this example, both members 7 and 8 are arranged with the same polarities N-S.

As shown in FIG. 18b, each of the driver and driven members 7,8 is mounted on a respective shaft 17, 18 that is carried in a respective bearing 27, 28 that allows both rotational and axial movement of the shaft 27, 28.

Due to the interacting magnetic forces, the driver and driven members 7,8 assume a mutual spaced equilibrium position where they interlock, as shown in FIG. 18b. When the driver member 7 is rotated, the driven member 8 follows it (and vice-versa should the driven member 8 be rotated). Also, when the driver member 7 is moved towards the driven member 8—to the left as seen—the driven member 8 moves also to the left. As shown in FIG. 18c, when the driven member 8 is moved towards the driver member 7—to the right as seen—the driver member 7 moves also to the right.

Thus, as described in the foregoing, a coupling as illustrated in FIGS. 18b and 18c can effectively transmit torque without contact, thereby reducing the need for seals and allowing objects such as walls to be placed between the driver and driven members 7,8.

If the driven member 8 is disposed inside the driver member 7 as shown in FIG. 18d, it will adopt an equilibrium position in which its N and S poles respectively oppose the S and N poles of the driver member 7. As seen in the cutaway view of FIG. 18e, the axial end face of the driven member 8 is axially spaced from a mounting 37 of the driver member. 7. As before, the bearings 27, 28 allow both rotational and axial movement of the shafts 27, 28 and each of the members 7, 8 follows rotational and axial movement of the other.

The mounting 37 may be of mild steel, to increase the torsional strength of the coupling and, optionally, may be extended to form a sleeve around the driver member 7, to increase magnetic strength. A metal sleeve may also be provided around the driven member 8.

FIG. 19 shows an arrangement of magnetic coupling, where the driver member 7 is configured to drive a circular wheel 9 comprising an array of axially polarised magnets, arranged in a circular pattern and thus forming a driven member 8. The axis of rotation of driver member 7 is at an angle of 90 degrees to the axis of rotation of the driven member 8.

FIG. 20 shows a cylindrical magnet 10 with plurality of notches about its periphery that define pole segments, and can be used to take up torque in rotation. The cylindrical magnet 10 is polarised perpendicularly to its axis of rotation. If a plurality of cylindrical magnets 10 are stacked together and their directions of polarisation are arranged such that they form a spiralling arrangement through the length of the spiral drive wheel 11, as shown in FIG. 21, the spiral drive wheel 11 forms a magnetic coupling member with spiralled north and south poles.

The spiral drive wheel 11 of FIG. 21 can be used to drive a circular wheel or array of magnets when magnetically coupled to it, as shown in FIG. 22. The magnets in such an arrangement form a magnetic worm drive, but without the energy losses associated with equivalent mechanical worm drives due to friction between connecting parts. The magnets within the driven member 8 or circular wheel, can be axially or radially polarised according to the placement of the spiral drive wheel 11 in relation to it. The gear ratio can be very great—ratios of 100:1 may be possible, for example.

FIG. 23 shows two spiral drive wheels 11 magnetically coupled as driver and driven members respectively. In this way, torque can be transmitted to neighbouring output shafts with parallel axes of rotation. The transmission is far smoother than that which can be achieved using solid block magnets, due to the spiralling polarisation arrangement. Such an arrangement of spiral drive wheels 11 can therefore be used for linear drive systems. Indeed, wherever rotational driver or driven members are shown and/or described in this specification, linear equivalents may be substituted.

Magnetic coupling members such as the members 1 and 10 may be manufactured from a rare earth (e.g. neodymium), which can be moulded and sintered, and cut to shape with diamond wires.

Magnetic couplings using embodiments of the invention may operate at virtually 100% efficiency and may withstand very high rotational speeds. The may be used in magnetic gearboxes with electric motors. For example, they may be used to drive an artificial heart pump.

Magnetic couplings using embodiments of the invention may comprise magnetic coupling members arranged in either circular concentric rings to form couplings, or in separate rings to form gears.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivates) indicates one feature or more that is preferred but not essential.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A magnetic coupling comprising first and second rotary coupling members arranged concentrically one inside the other, each having around its periphery a respective series of permanent magnets that project radially from the coupling member; wherein, for each of the series, each of the magnets has opposite faces of opposite polarity and consecutive magnets are spaced from one another with said faces of consecutive magnets of alternating polarity; the coupling members being juxtaposed with the respective series of magnets disposed opposite but offset from one another such that each of the magnets of each series projects into a space between two magnetics of the other series with opposing faces being of opposite polarity.

2-4. (canceled)

5. A magnetic coupling according to claim 1, wherein said magnets are of rhomboid shape.

6. (canceled)

7. A magnetic coupling according to claim 1, wherein at least one of the coupling members comprising a carrier and a plurality of permanent magnets mounted on the carrier, wherein each of the magnets is formed with at least one recess and a plurality of rods are provided on the carrier and engage the recesses to secure the magnets on the carrier.

8. A magnetic coupling according to claim 7, wherein each of the magnets that is formed with at least one recess has a pair of said recesses at opposite sides of a base portion of the magnet.

9. A magnetic coupling according to claim 7, wherein said carrier comprises a pair of elements arranged with the magnets between them, each of the elements carrying a series of rods that alternate with the rods on the other of the elements.

10-11. (canceled)

12. A magnetic coupling according to claim 7, wherein said rods are in the form of bolts.

13-20. (canceled)

21. A magnetic coupling according to claim 1, wherein each permanent magnet comprises a rare earth material.

22. A magnetic coupling according to claim 21, wherein said rare earth material comprises neodymium.

23-27. (canceled)
